(19) United States
(12) Patent Application Publication
(10) Pub. No.: US 2022/0356377 A1
(43) Pub. Date: Nov. 10, 2022

(54) UV CURED EXOTHERMIC SELF-ADHESIVE REPAIR SHEETS

(71) Applicant: Unmatched Bonding Company, LLC, Forth Worth, TX (US)

(72) Inventor: Ryan Michael Jones, Fort Worth, TX (US)

(73) Assignee: Unmatched Bonding Company, LLC, Fort Worth, TX (US)

(21) Appl. No.: 17/765,624

(22) PCT Filed: Oct. 2, 2020
(86) PCT No.: PCT/US20/53913

§ 371 Date: Mar. 31, 2022

Related U.S. Application Data
(60) Provisional application No. 62/909,381, filed on Oct. 2, 2019.

(51) Int. Cl. C09J 7/38; C09J 7/10; B32B 7/12; B32B 27/08; B32B 27/30; B32B 27/36; B32B 27/20

(52) U.S. Cl. CPC C09J 7/38; C09J 7/10; B32B 7/12; B32B 27/08; B32B 27/308; B32B 27/36; B32B 27/302; B32B 27/20; C08K 3/36

(57) ABSTRACT

A UV-cured exothermic self-adhesive repair sheet having two components that may be combined in equal sizes. The first component comprises Polyester Resin (25-40%), Glass Fiber (15-25%), Styrene Monomer (<20%) and Inorganic Filler (25-40%). The second component comprises Acrylic Adhesive (75-95%) and Non-Woven Fabric (5-25%).

### CROSS-REFERENCE TO RELATED APPLICATIONS

The present application claims the benefit of the filing date of U.S. Provisional Patent Application Ser. No. 62/909,381 filed by the present inventors on Oct. 2, 2019.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

### Field of the Invention

The present invention relates to materials and products for repair, for example, of tile, pipe, or other materials.

### Brief Description of the Related Art

Self-Adhesive Repair Materials exist in many forms and designs. However, one of the major drawbacks is the minimum temperature requirements for the adhesive to set up and bond properly. Typical Self-Adhesive repair systems, especially PSA (Pressure Sensitive Adhesive) systems cannot be applied below freezing temperatures (32 F) and their initial tack and overall function begin to diminish significantly under (50 F).

There is a need for a one-component soft/pliable Self-Adhesive repair material that can be cured to a greater than 50 BARCOL hardness in less than 5 minutes and can be applied successfully in Sub-Freezing temperatures.

### SUMMARY OF THE INVENTION

WI In a preferred embodiment, the present invention is a UV-cured exothermic self-adhesive repair sheet having two components or layers. The first component or layer comprises 25-40% polyester resin, 15-25% glass fiber, styrene monomer, wherein the styrene monomer is less than 20% of the first component, and 25-40% inorganic filler. The second component or layer is comprised of 75-95% acrylic adhesive and 5-25% non-woven fabric. The first and second components are combined in equal sizes. The inorganic filler may be at least one of silica glass, quartz powder, silicon dioxide and aluminum hydroxide. The UV-cured exothermic self-adhesive repair sheet further may have a transparent releasable cover on the first component and/or a releasable external liner on the second component.

In another embodiment, the present invention is a UV-cured exothermic self-adhesive repair sheet comprising a polyester resin layer and an acrylic adhesive layer, wherein the polyester resin layer has a composition that produces heat of 140° F.-200° F. for at least one minute when said polyester resin layer is cured.

In another embodiment, the present invention is a method for repairing a surface with a UV-cured exothermic self-adhesive repair sheet. The UV-cured exothermic self-adhesive repair sheet having two components or layers. The first component or layer comprises 25-40% polyester resin, 15-25% glass fiber, styrene monomer, wherein the styrene monomer is less than 20% of the first component, and 25-40% inorganic filler. The second component or layer is comprised of 75-95% acrylic adhesive and 5-25% non-woven fabric. The first and second components are combined in equal sizes. The inorganic filler may be at least one of silica glass, quartz powder, silicon dioxide and aluminum hydroxide. The UV-cured exothermic self-adhesive repair sheet further may have a transparent releasable cover on the first component and/or a releasable external liner on the second component.

The method comprises cleaning and drying the surface to be repaired, cleaning the surface to be repaired with acetone, removing a UV cured self-adhesive repair sheet from a sealed pouch, cutting the UV-cured exothermic self-adhesive repair sheet to a size corresponding to the surface to be repaired, peeling off the backing of the UV-cured exothermic self-adhesive repair sheet to reveal the resin, pressing the resin side of the UV-cured exothermic self-adhesive repair sheet to the surface to be repaired to adhere the repair sheet to the surface, pressing firmly around the edges of the UV-cured exothermic self-adhesive repair sheet to create an airtight and watertight seal between the surface to be repaired and the UV-cured exothermic self-adhesive repair sheet, and applying UV light to the UV-cured exothermic self-adhesive repair sheet for a sufficient amount of time to cure the UV-cured exothermic self-adhesive repair sheet. Preferably, the UV light is applied for a period of time greater than 2 minutes and less than or equal to 5 minutes. Other lengths of curing time are possible with the present invention. The method may further comprise removing the external liner from the UV-cured exothermic self-adhesive repair sheet. Still further, the method may comprise drilling, sand or painting the UV-cured exothermic self-adhesive repair sheet after the step of applying UV light to the UV-cured exothermic self-adhesive repair sheet to cure the UV-cured exothermic self-adhesive repair sheet.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a flow chart of a process for applying a UV polyester resin reinforced with mineral fillers repair sheet in accordance with a preferred embodiment of the present invention.

FIG. 2 is a cross-sectional view of a UV polyester resin reinforced with mineral fillers repair sheet in accordance with a preferred embodiment of the present invention.

FIG. 3A is a front view of a UV polyester resin reinforced with mineral fillers repair sheet in accordance with a preferred embodiment of the present invention showing a transparent cover sheet on the exposed side of the resin.

FIG. 3B is a perspective view of a UV polyester resin reinforced with mineral fillers repair sheet in accordance with a preferred embodiment of the present invention showing a release liner on the exposed side of the acrylic adhesive.

FIG. 3C is a perspective view of a UV polyester resin reinforced with mineral fillers repair sheet in accordance with a preferred embodiment of the present invention showing the release liner being removed.

FIG. 3D is a view of a UV polyester resin reinforced with mineral fillers repair sheet in accordance with a preferred embodiment of the present invention on a pipe showing the transparent cover sheet being removed.

FIG. 4A is an image of a broken pipe to be repaired using a UV polyester resin reinforced with mineral fillers repair sheet in accordance with a preferred embodiment of the present invention.

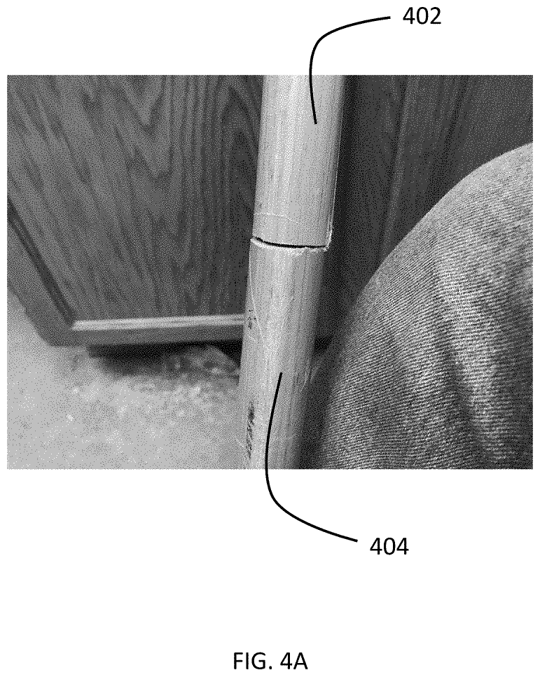

FIG. 4B is an image of the broken pipe of FIG. 4A after application of a UV polyester resin reinforced with mineral fillers repair sheet in accordance with a preferred embodiment of the present invention.

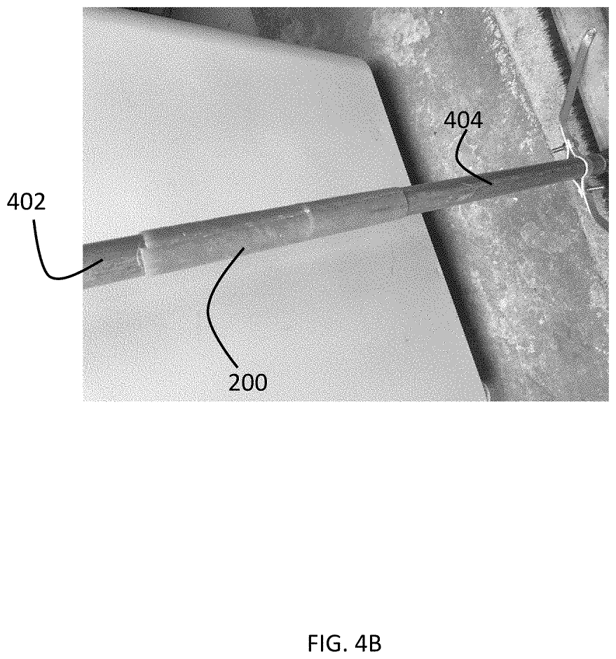

### DETAILED DESCRIPTION OF THE PREFERRED EMBODIMENTS

In a preferred embodiment, the present invention is a UV cured repair sheet that consists of an ultraviolet (UV) polyester resin reinforced with mineral fillers, and man-made vitreous fibers in the form of a chopped strand mat. also, includes a curing cross-linking agent such as Styrene.

The polyester resin is designed to release heat during the curing process. This release of heat will reach approx. 140° F.-200° F. for 1-2 minutes.

A UV-cured repair sheet in accordance with the present invention has several components or layers. The first component or layer is the resin layer (Component 1), which can be presented in small sizes (1 sq. inch) and large sizes up to 3 ft×30 ft sheets. The repair sheets may be of thicknesses from 20 mils to 400 mils. The composition of Component 1 is as follows:
1) Polyester Resin: 25-40%;
2) Glass Fiber: 15-25% (CAS NO. 65997-17-3);
3) Styrene Monomer: <20% (CAS NO. 100-42-5); and
4) Inorganic Filler: 25-40%.

The inorganic filler (mineral filler) may be silica glass (CAS NO. 60676-86-0), quartz powder (CAS No. 14808-60-7), silicon dioxide (CAS No. 112945-52-5) or Aluminum Hydroxide (CAS #21645-51-2),

Component 2 is a self-adhesive system. Component 2 may be a double sided, double coated acrylic adhesive Tissue-like Tape with a release liner. Component 2 is comprised of a strong, high tensile strength, flexible non-woven fabric impregnated with Acrylic adhesive and has a range of thickness from 4 mils to 40 mils. The composition of Component 2 is as follows:
1) Acrylic Adhesive: 75-95%;
2) Non-Woven Fabric: 5-25%; and
3) Release Liner: Optional.

Component 1 and Component 2 are combined equal size/shape.

The Self-Adhesive Tissue Tape with Acrylic Adhesive is a PSA (Pressure Sensitive Adhesive). The adhesive bonds to the substrate by a “Wet Out” process. The acrylic adhesive acts as a liquid and slowly flows into the micro porosity and micro abnormalities. At 50° F. the “Wet Out” process is significantly inhibited. At or below 32 F the “Wet Out” process is reduced to the point of near ineffectiveness and can easily fail.

The special “Heat-Release” method of the present invention with the UV-cured resin sheets combined with the Self-Adhesive Tissue Tape will ensure a superior bond and intended function not just in normal temperatures, but even in SUB ZERO conditions.

In another preferred embodiment the present invention is a kit including:
1) UV-cured exothermic repair sheet;
2) 91% Isopropyl Alcohol Wipe; and
3) preferred UV XL FLASHLIGHT.

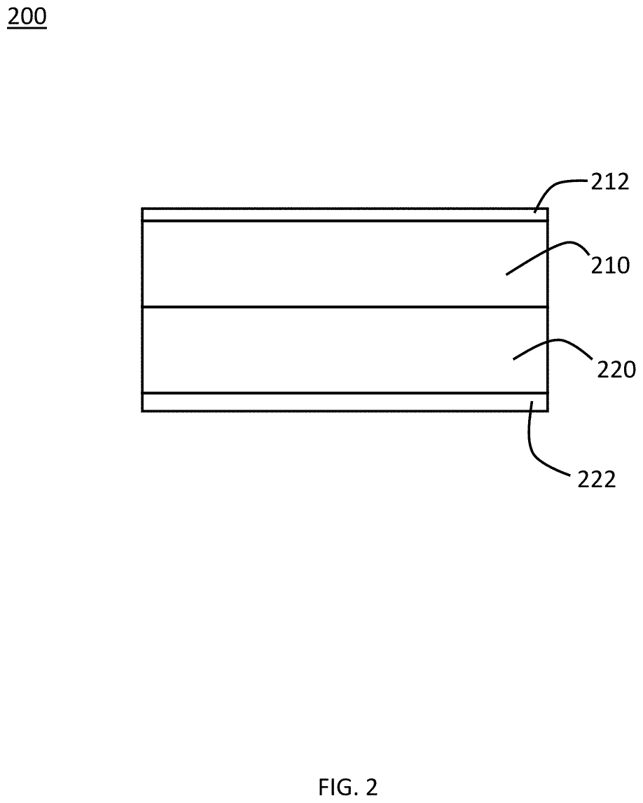

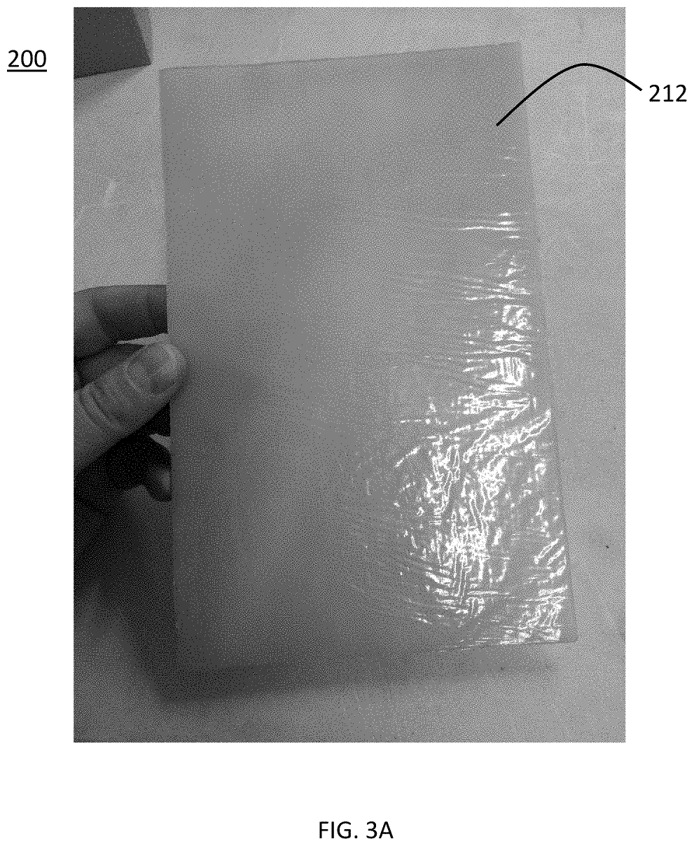

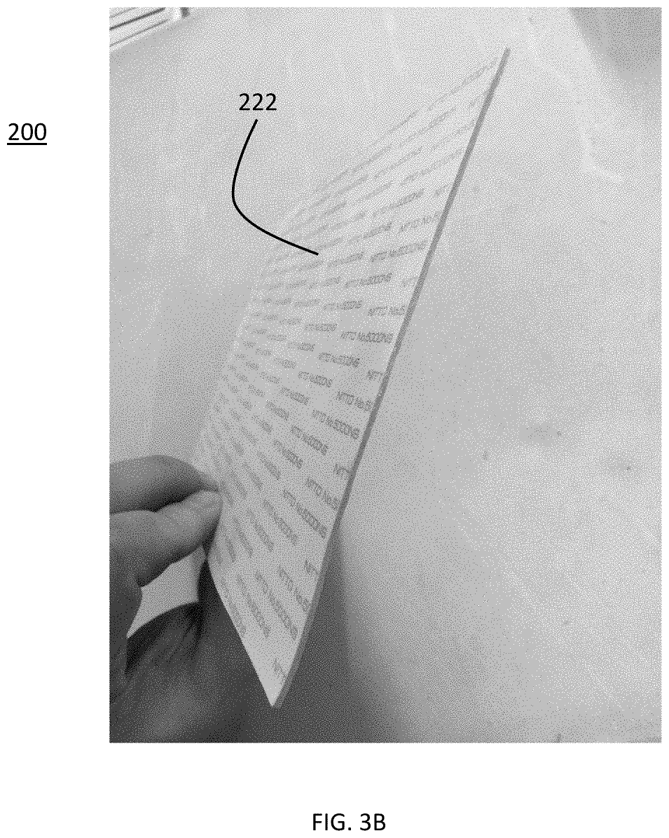

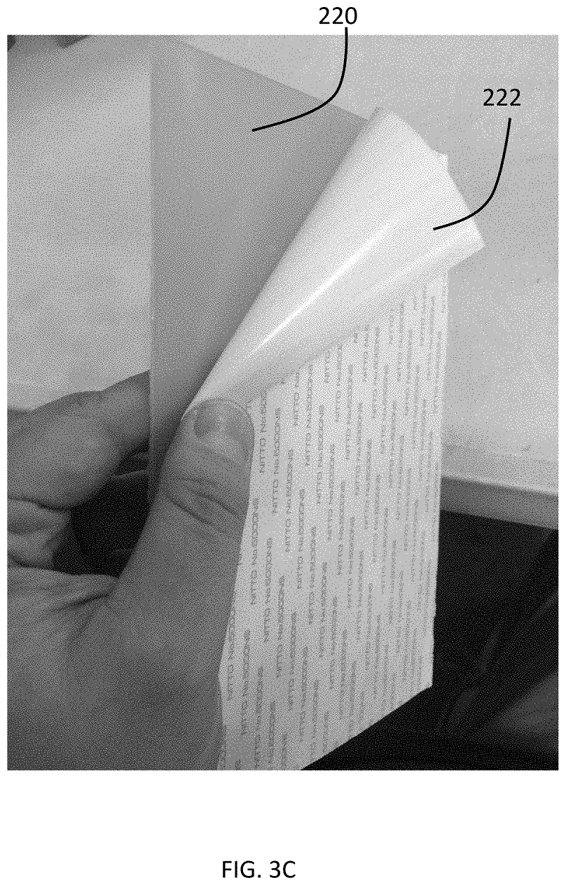

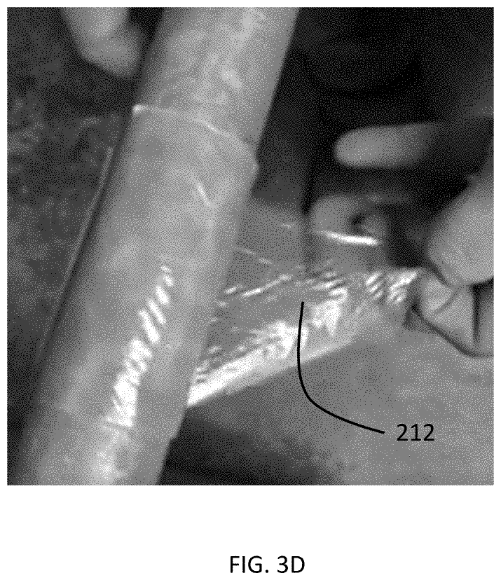

In a preferred embodiment, Components 1 and 2 are combined in a repair patch 200 as shown in FIG. 2. Component 1 (210) has a backing or cover (212) on one side. The cover or backing 212 may be transparent. Component 2 (220) has a release liner (222) on one side. The exposed side of Component 2 (220) is pressed onto the exposed side of Component 1 to adhere the two Components to one another. The finished repair sheet 200 is shown in FIGS. 3A-3C.

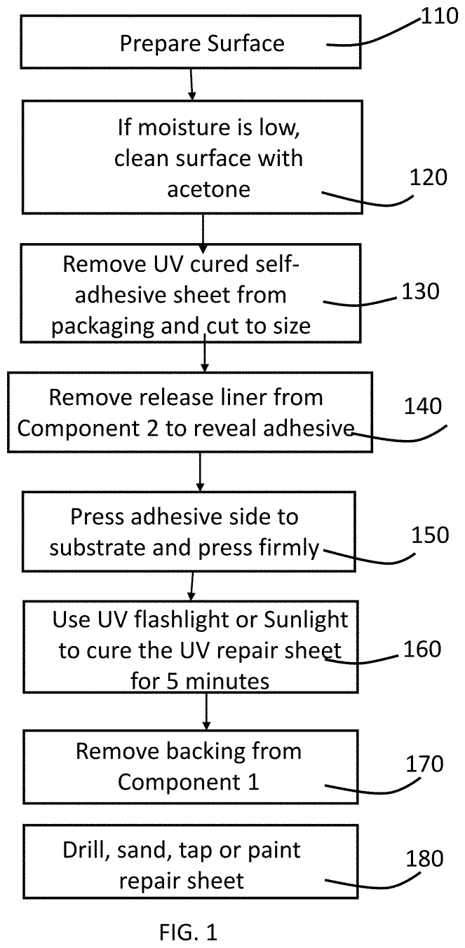

The method for using the repair patch is shown in FIG. 1. The surface to be repaired is prepared (110) by cleaning and drying the surface and making sure it is free from contaminants. If moisture is an issue due to low temperatures or Dew Point, clean the surface to be repaired with acetone (120). Remove a UV cured self-adhesive repair sheet from its sealed pouch (not shown) and cut to size if needed (130). Peel off the backing or release liner 222 to reveal the sticky side (140). Press the sticky side to the surface to be repaired (the substrate) and press firmly to adhere the repair sheet to the surface and press out any air bubbles (150). Be sure to press firmly on edges to create an airtight and watertight seal. A UV light source such as a UV flashlight or sunlight is shone onto the repair sheet for 5 minutes (160) to cure the UV repair sheet. Remove the external liner 212 if the repair sheet has one (170). While a curing time of 5 minutes is used in a preferred embodiment, the present invention is not limited to curing for that amount of time. When fully cured the repair sheet 200 can be drilled, sanded, tapped, or painted (180).

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

1. A UV-cured exothermic self-adhesive repair sheet comprising:
a first component comprising:
25-40% polyester resin;
15-25% glass fiber;
styrene monomer, wherein said styrene monomer is less than 20% of the first component; and
25-40% inorganic filler; and
a second component comprising:
75-95% acrylic adhesive; and
5-25% non-woven fabric;
wherein the first and second components are combined in equal sizes.

2. A UV-cured exothermic self-adhesive repair sheet according to claim 1, wherein said inorganic filler comprises at least one of silica glass, quartz powder, silicon dioxide and aluminum hydroxide.

3. A UV-cured exothermic self-adhesive repair sheet according to claim 1, further comprising a releasable cover on said first component of said UV-cured exothermic self-adhesive repair sheet.

4. A UV-cured exothermic self-adhesive repair sheet according to claim 3, wherein said releasable cover on said first component of said UV-cured exothermic self-adhesive repair sheet is transparent.

5. A UV-cured exothermic self-adhesive repair sheet according to claim 1, further comprises a releasable external liner on said second component of said UV-cured exothermic self-adhesive repair sheet.

6. A UV-cured exothermic self-adhesive repair sheet comprising a polyester resin layer and an acrylic adhesive layer, wherein said polyester resin layer has a composition that produces heat of 140° F.-200° F. for at least one minute when said polyester resin layer is cured.

7. A method for repairing a surface with a UV-cured exothermic self-adhesive repair sheet comprising:
cleaning and drying the surface to be repaired;
cleaning the surface to be repaired with acetone;
removing a UV cured self-adhesive repair sheet from a sealed pouch, wherein said UV cured self-adhesive repair sheet comprises:
a first component comprising:
25-40% polyester resin;
15-25% glass fiber;
styrene monomer, wherein said styrene monomer is less than 20% of the first component; and
25-40% inorganic filler; and
a second component comprising:
75-95% acrylic adhesive; and
5-25% non-woven fabric;
wherein the first and second components are combined in equal sizes;
cutting said UV-cured exothermic self-adhesive repair sheet to a size corresponding to said surface to be repaired;
peeling off the backing of the UV-cured exothermic self-adhesive repair sheet to reveal the resin;
pressing the resin side of the UV-cured exothermic self-adhesive repair sheet to the surface to be repaired to adhere the repair sheet to the surface;
pressing firmly around the edges of the UV-cured exothermic self-adhesive repair sheet to create an airtight and watertight seal between the surface to be repaired and the UV-cured exothermic self-adhesive repair sheet; and
applying UV light to the UV-cured exothermic self-adhesive repair sheet for a sufficient period of time to cure the UV-cured exothermic self-adhesive repair sheet.

8. A method for repairing a surface with a UV-cured exothermic self-adhesive repair sheet according to claim 7 wherein said UV-cured exothermic self-adhesive repair sheet has an external liner on said second component, further comprising:
removing the external liner from said UV-cured exothermic self-adhesive repair sheet.

9. A method for repairing a surface with a UV-cured exothermic self-adhesive repair sheet according to claim 7 further comprising drilling, sand or painting said UV-cured exothermic self-adhesive repair sheet after said step of applying UV light to the UV-cured exothermic self-adhesive repair sheet to cure the UV-cured exothermic self-adhesive repair sheet.

10. A method for repairing a surface with a UV-cured exothermic self-adhesive repair sheet according to claim 7 wherein said UV light is applied for a period of less than 5 minutes.

11. A method for repairing a surface with a UV-cured exothermic self-adhesive repair sheet according to claim 7 wherein said UV light is applied for a period of time greater than 2 minutes but less than or equal to 5 minutes.
